(19) United States
(12) Patent Application Publication
(10) Pub. No.: US 2015/0298117 A1
(43) Pub. Date: Oct. 22, 2015

(54) CLEAN ROOM SEPTUM

(71) Applicant: Dompé farmaceutici S.p.A., Milano (IT)

(72) Inventor: FERRONI Alessandro, PERUGIA (IT)

(21) Appl. No.: 14/689,352

(22) Filed: Apr. 17, 2015

(30) Foreign Application Priority Data
Apr. 18, 2014 (IT) MI2014A000732

(51) Int. Cl. B01L 1/02; E03C 1/02; E04C 2/52; F24F 7/10

(52) U.S. Cl. CPC B01L 1/02; F24F 7/10; E03C 1/021; E04C 2/526

(57) ABSTRACT

A clean room septum, usable for clean rooms of the type including one controlled-atmosphere room having one partitioning wall configured to separate a controlled-atmosphere environment inside the room from an external not controlled-atmosphere environment. The septum includes one main body having a plurality of openings substantially identical to each other, a plurality of intermediate bodies, each of which is adapted to be stably engaged with the through openings. The intermediate bodies include a plurality of connecting elements and a plurality of closing elements: the connecting elements have a through hole and an attachment device suitable for being connected to operative machines housed inside the room, while the closing elements are hermetically engageable with the through openings.

### TECHNICAL FIELD

The present invention regards a septum, for example for controlled-atmosphere rooms, such as sterile rooms, clean rooms, or safety rooms intended to house the production/handling of toxic agents or rooms in any case classified as controlled-atmosphere. The invention also regards a controlled-atmosphere clean room using such septum and a process for the arrangement thereof. The rooms in question and the respective septum are employed in the chemical-pharmaceutical field or biotechnology for the preparation of drugs or active principles, for microorganism culture, etc. The rooms and the respective septum can also be used for making scientific research laboratories.

### BACKGROUND

The development and preparation of drugs or microorganism culture are characterized by complex processes, long in terms of time and particularly costly. Such processes also have high risks in terms of personnel safety, since they can provide for the use of toxic substances and/or health-damaging microorganisms. In addition, the possible contamination of such substances/microorganisms can cause damage or an undesired alteration in the drug/active principle/culture to be produced.

For such reasons, the treatment of the substances intended to form drugs or active principles for drugs, as well as the treatment of microorganism culture, are executed within suitable clean environments (controlled-atmosphere rooms such as clean rooms) whose main characteristic is the obtainment of a room with a high level of isolation with respect to the outside (of course depending on the type of process housed within the environment) and the presence of controlled atmosphere: for example, clean air, super-filtered air, with very low content of suspended dust micro-particles, or other polluting agents.

Depending on the type of process/processes present in the controlled-atmosphere room, the room itself can house different operative machines dedicated for example to steps of treatment such as fermentation, centrifuge, homogenization, sterilization among others. As can be easily understood, the various operative machines must be interfaced with the external environment in order to receive the substances to be treated, the work fluids and the like. Each of the operative machines is therefore installed in the room so as to safely receive such substances to be treated, operative fluids etc., without compromising the quality of the atmosphere present in the room itself.

For this purpose, controlled-atmosphere rooms are known today that are equipped with a connection panel adapted to define a part of the separation wall of the room itself from an external environment. Openings or through channels are present on the panel which are arranged in pre-established positions and with pre-established size. The openings are designed in a manner such to receive—on the not controlled-atmosphere environment side, outside the room, also defined the “dirty” side—a series of tubes bringing the substances/fluids useful for the operative machines present in the controlled-atmosphere room; such openings then receive—on the side inside the clean room—tubes directed to the various operative machines. The position and size of each opening is designed so as to serve a specific tube directed to a specific operative machine. Due to the connection panel, it is possible to introduce inside the room the work fluids/substances useful for the operative machines as well as discharge possible waste fluids/substances and simultaneously keep the atmosphere inside the room itself controlled.

Even if the above-described solution allows maintaining a controlled environment inside the rooms even during the exchange of substances/work fluids/waste fluids between the room interior and exterior, certain problems persist.

Firstly, the solutions of known type are not very flexible. For this purpose, it is useful to note that often the production of pharmaceutical products or microorganism cultures is generally initially obtained by means of pilot plants. Such plants typically have controlled-atmosphere rooms, where a minimum number of operative machines operate that are, for example, suitable for obtaining limited product quantities. The final plant for large-scale production generally requires a greater number of operative machines, and hence a proportionally greater number of ducts that place such machines in communication with the external environment, or existing operative machines generally require the connection of additional fluids not initially provided for. Often, in the passage from pilot productions to large-scale productions, it is also necessary to increase the size of the substance exchange ducts between the environment inside the room and that outside. The addition of devices operating inside the room and the addition of new fluid connections with the outside typically requires the addition of new openings on the connection panel and/or the size modification thereof. Some clean rooms known today, during the passage from pilot plant to large-scale production, require the modification or even the complete substitution of the connection panel. In both conditions, it can be necessary to remove the whole connection panel for its modification or substitution with subsequent dismantling of the room and loss of the controlled-atmosphere conditions. After these operations, the controlled-atmosphere conditions may have to be entirely re-established before proceeding with the reactivation of the various processes housed in the room, with clear disadvantages in terms of times and costs. In addition, the clean rooms known today cannot always be adapted to the variations of the productive process: the addition or even only the modification of a device inside the clean room may require operation on the connection panel, with consequent loss of control of the quality of the atmosphere inside the room. The general absence of flexibility indicates high costs, influenced by the operations on the connection panel for the modification or substitution thereof. In addition, considerable energy may be required during the redefinition of the controlled environment following the contamination thereof: in fact, after having completed the operations on the panel, it may be necessary to execute room purification cycles in order to re-establish the desired level of controlled atmosphere within the room.

### SUMMARY

In some examples, the invention features a connection septum—interposable between the controlled-atmosphere environment of a room, e.g. a clean room, and the external environment—which is particularly flexible and adaptable to the various configurations of the room itself. In some cases, the same septum can be used for the clean room both in pilot plant configuration and in plant configuration aimed for large-scale production.

The septum may allow a simple and quick reconfiguration of the room with regard to the connection with the operative devices or machines present inside such room. In some cases, a septum is adapted to reduce or minimize the times for achieving a direct fluid communication between the controlled environment and the external environment, during the steps of reconfiguration of the room.

The septum may be adapted to promote the airtight seal of the room, in particular preventing the passage of contaminating substances to the interior of the controlled environment of the room itself. In some cases, a process is provided for arranging rooms, such as laboratory rooms, clean rooms or safety rooms, that is particularly simple and safe which prevents—after the definition of the controlled environment—the contamination thereof. The process is capable of maintaining the controlled environment conditions inside the room even during the steps of modification and/or arrangement of the septum.

The septum may be used for obtaining rooms for producing drugs and/or microorganism culture.

In a first aspect, a septum is provided, for example usable for controlled-atmosphere clean rooms having at least one partitioning wall configured to separate an inner controlled-atmosphere environment from an external not controlled-atmosphere environment. The septum includes:
at least one main body configured to define at least part of the partitioning wall, the main body defining a plurality of through openings, which may be identical or substantially identical to each other in shape and size;
a plurality of intermediate bodies, each of which is configured to stably engage the through openings, each intermediate body extending between a first and second main development surface respectively configured to be arranged towards the controlled-atmosphere environment and towards the external environment. The intermediate bodies include:
   at least one plurality of connecting elements engageable with the through openings, each connecting element having at least one through hole and an inner attachment device at the through hole. The inner attachment device is suitable for being connected to operative devices or machines housed inside the room.
   at least one plurality of closing elements, each of which is hermetically engageable with the through openings.

In a second aspect in accordance with the preceding aspect, each connecting element has a coupling surface suitable for being interchangeably combined with each of the openings.

In a third aspect in accordance with any one of the preceding aspects, the closing elements has the same, or substantially the same, shape and size, the closing elements being interchangeably and closeably engageable with each of the through openings.

In a fourth aspect in accordance with any one of the preceding aspects, each closing element has a coupling surface suitable for being interchangeably combined with each of the through openings.

In a fifth aspect in accordance with the preceding aspect, the coupling surfaces, respectively of the connecting elements and the closing elements, are identical or substantially identical to each other in shape and size.

In a sixth aspect in accordance with any one of the preceding aspects, the septum includes at least one frame suitable for being engaged with at least one through window of the partitioning wall, the main body including at least one panel configured to stably engage the frame.

In a seventh aspect in accordance with the preceding aspect, the panel is at least partly made of metal material.

In an eighth aspect in accordance with the sixth or seventh aspect, the panel is made of or includes at least one of the following materials: steel, aluminum.

In a ninth aspect in accordance with any one of the preceding aspects, each of the connecting elements has at least one external attachment device engaged at the through hole, opposite to and in fluid communication with the respective inner attachment device via the through hole.

In a tenth aspect in accordance with any one of the preceding aspects, the closing elements include blind bodies devoid of through openings.

In an eleventh aspect in accordance with any one of the preceding aspects, each closing element is configured to hermetically close the through opening with which it is associated.

In a twelfth aspect in accordance with any one of the preceding aspects, the through openings are arranged in a substantially uniform manner on multiple rows, to essentially define a matrix of through openings.

In a thirteenth aspect in accordance with any one of the preceding aspects, two adjacent or immediately adjacent through openings are arranged at a minimum distance greater than 15 mm (e.g., between 20 and 60 mm, or between 30 and 50 mm), with the minimum distance between two adjacent or immediately adjacent through openings being defined by the minimum distance between the perimetral edges defining the openings.

In a fourteenth aspect in accordance with any one of the preceding aspects, two immediately consecutive through openings are arranged at a minimum distance from each other (e.g., between 20 and 60 mm, or between 30 and 50 mm), the minimum distance between two immediately consecutive openings being measured along a first horizontal trajectory and being defined by the minimum distance between the perimetral edges defining the openings.

In a fifteenth aspect in accordance with any one of the preceding aspects, the openings are uniformly distributed along a first trajectory.

In a sixteenth aspect in accordance with the preceding aspect, the first trajectory is extended horizontally according to a use condition of the septum.

In a seventeenth aspect in accordance with the preceding aspect, the septum defines a number of openings per linear meter along the first trajectory (e.g., between 3 and 10, or between 4 and 7).

In an eighteenth aspect in accordance with any one of the preceding aspects, two immediately consecutive through openings along a second vertical trajectory may be arranged at a minimum distance from each other (e.g., between 50 and 200 mm, or between 80 and 160 mm), the minimum distance between two immediately-consecutive openings along the second trajectory being defined by the minimum distance between the perimetral edges defining the openings.

In a nineteenth aspect in accordance with any one of the preceding aspects, the openings are also uniformly or substantially uniformly distributed along a second trajectory.

In a twentieth aspect in accordance with the preceding aspect, the second trajectory is extended vertically according to a use condition of the septum.

In a twenty-first aspect in accordance with the preceding aspect, the openings of the second series are uniformly distributed along the second trajectory.

In a twenty-second aspect in accordance with any one of the preceding aspects, the septum includes a number of openings per linear meter along the second trajectory (e.g., between 3 and 8, or between 3 and 6).

In a twenty-third aspect in accordance with any one of the preceding aspects, the openings are uniformly or substantially uniformly distributed on the main body to define a rectangular matrix of openings.

In a twenty-fourth aspect in accordance with any one of the preceding aspects, the main body includes a number of openings (e.g., between 15 and 50, or between 25 and 35).

In a twenty-fifth aspect in accordance with any one of the preceding aspects, each through opening has a through area between 120 and 315 cm², or between 150 and 250 cm².

In a twenty-sixth aspect in accordance with any one of the preceding aspects, each opening has a minimum size defined by the minimum distance between two opposite edges of the opening (e.g., between 120 and 200 mm, or between 150 and 180 mm).

In a twenty-seventh aspect in accordance with any one of the preceding aspects, each intermediate body has an external perimetral edge defining a front area greater than the through area of each opening, the external perimetral edge overlappingly acting on a perimetral edge defining the opening with which the intermediate body is associated.

In a twenty-eighth aspect in accordance with the preceding aspect, the front area of each intermediate body, delimited by the external perimetral edge, is between 150 and 350 cm², or between 200 and 300 cm².

In a twenty-ninth aspect in accordance with any one of the preceding aspects, each intermediate body has a minimum size defined by the minimum distance between two opposite edges of the intermediate body (e.g., between 140 and 220 mm, or between 170 and 195 mm).

In a thirtieth aspect in accordance with any one of the aspects from 27° to 29°, the ratio between the front area of the intermediate body and the through area of the opening is greater than 1, or between 1 and 1.5.

In a thirty-first aspect in accordance with any one of the preceding aspects, the main body has an external perimetral edge laterally defining the main body, the external perimetral edge defining an extended surface area of the main body.

In a thirty-second aspect in accordance with the preceding aspect, the external perimetral edge has an area between 6,000 and 26,000 cm², or between 10,000 and 20,000 cm².

In a thirty-third aspect in accordance with any one of the preceding aspects, the ratio between the area of the main body and the total through area of all the openings is between 2 and 5, or between 2 and 4.

In a thirty-fourth aspect in accordance with any one of the aspects from 6° to 33°, the panel has a plate-like body.

In a thirty-fifth aspect in accordance with any one of the aspects from 6° to 34°, the panel has a thickness between 3 and 7 mm or between 4 and 6 mm.

In a thirty-sixth aspect in accordance with any one of the preceding aspects, the main body has a rectangular shape.

In a thirty-seventh aspect in accordance with any one of the preceding aspects, the openings have a circular shape.

In a thirty-eighth aspect in accordance with any one of the preceding aspects, the intermediate bodies are counter-shaped with respect to the through openings.

In a thirty-ninth aspect in accordance with any one of the preceding aspects, the intermediate bodies have a discoid shape.

In a fortieth aspect in accordance with any one of the preceding aspects, the septum includes at least one auxiliary body configured to define at least part of the partitioning wall, the auxiliary body being placed opposite the main body with respect to the partitioning wall itself, the auxiliary body including a plurality of through openings that are identical or substantially identical to each other and in opposition to the plurality of through openings of the main body.

In a forty-first aspect in accordance with the preceding aspect, the auxiliary body includes a panel configured to engage the frame.

In a forty-second aspect in accordance with the preceding aspect, the panel of the auxiliary body is at least partly made of metal material.

In a forty-third aspect in accordance with aspect 41° or 42°, the panel is made of or includes at least one of the following materials: steel, aluminum.

In a forty-fourth aspect in accordance with any one of the aspects from 40° to 43°, at least the plurality of through openings of the auxiliary body is substantially identical in shape and size to the plurality of through openings of the main body.

In a forty-fifth aspect in accordance with any one of the aspects from 40° to 44°, the closing elements of the intermediate bodies are interchangeably engageable with each of the through openings of the auxiliary body.

In a forty-sixth aspect in accordance with any one of the aspects from 41° to 45°, the panel of the auxiliary body is substantially identical to the panel of the main body (2).

In a forty-seventh aspect in accordance with any one of the preceding aspects, the intermediate bodies are at least partly made of metal material.

In a forty-eighth aspect in accordance with any one of the preceding aspects, each of the intermediate bodies is at least partly made of at least one of the following materials: steel, aluminum.

In a forty-ninth aspect, a clean room is provided including:
a plurality of partitioning walls defining a controlled-atmosphere environment,
at least one filtration device configured to supply filtered air for defining the controlled-atmosphere environment,
at least one septum in accordance with any one of the preceding aspects and defining at least part of one of the partitioning walls.

In a fiftieth aspect in accordance with the preceding aspect, at least one of the partitioning walls includes at least one through window engaging at least one main body of the septum.

In a fifty-first aspect in accordance with the preceding aspect, the window engages at least one main body arranged towards the controlled-atmosphere environment and at least one auxiliary body, opposite the main body, arranged towards the external environment.

In a fifty-second aspect in accordance with aspect 50° or 51°, the septum has at least one frame stably engaged with the window.

In a fifty-third aspect in accordance with the preceding aspect, the frame constrains, on one side, the main body, and on an opposite side it constrains the auxiliary body.

In a fifty-fourth aspect in accordance with any one of the aspects from 52° to 53°, the frame, along with the main body and auxiliary body, defines at least one gap configured to house at least one plurality of inner attachment devices of the connecting elements.

In a fifty-fifth aspect in accordance with any one of the aspects from 49° to 54°, the partitioning wall includes a plurality of windows that are separate and spaced from each other.

In a fifty-sixth aspect in accordance with any one of the aspects from 49° to 55°, the room includes at least two windows that differ from each other in shape and/or size, each of the windows engaging respective septa that also differ from each other in shape and/or size.

In a fifty-seventh aspect in accordance with any one of the aspects from 49° to 56°, the room includes:
a plurality of external perimetral partitioning walls defining at least one room devoid of windows,
a plurality of operative partitioning walls emerging from the external perimetral partitioning walls according to a direction entering the room, the operative partitioning walls having one or more windows and supporting one or more of the septa.

In a fifty-eighth aspect, there is a process for providing a clean room in accordance with any one of the aspects from 49° to 57°, including at least the following steps:
providing a plurality of partitioning walls defining a controlled-atmosphere environment,
providing, at least one partitioning wall, and at least one septum in accordance with any one of the aspects from 1° to 48°, the septum being configured to define at least part of the partitioning wall,
   and wherein providing the septum includes providing at least one main body configured to define at least part of the partitioning wall.

In a fifty-ninth aspect in accordance with the preceding aspect, engaging, with each of the through openings, the intermediate bodies includes:
engaging at least one plurality of connecting elements with at least one pre-established number of through openings, and
hermetically engaging at least one plurality of closing elements with a pre-established number of through openings.

In a sixtieth aspect in accordance with any one of the preceding aspects of the process, the main body is arranged towards the controlled-atmosphere environment, the process further including:
providing at least one at least one auxiliary body opposite the main body for defining at least part of the partitioning wall arranged towards the external environment,
forming on the auxiliary body a plurality of through openings substantially identical to each other in shape and size and arranged to stably engage the intermediate bodies,
engaging, with each through opening of the auxiliary body, a respective closing element to inhibit or prevent the fluid communication between the external environment and controlled-atmosphere environment,
engaging, with each through opening of the main body, a connecting element or a closing element,
connecting the connecting elements engaged with the main body with operative machines housed inside the room.

In a sixty-first aspect in accordance with the preceding aspect, the process includes preparing the external environment, preparing including at least one of:
after the engagement of the connecting elements or closing elements with the main body, removing at least some of the closing elements placed on the auxiliary body for enabling the access from outside the room to the main body
connecting the connecting elements associated with the main body to respective supplying devices, placed in the external environment, so that the latter are in fluid communication with the operative machines housed inside the room, the connecting elements being at least configured to manage the passage of substances arriving from supplying devices and directed towards the operative machines.

In a sixty-second aspect, there is a process for repairing and/or substituting a septum, in accordance with any one of the aspects from 1° to 48°, for a clean room with controlled-atmosphere environment, in accordance with any one of the aspects from 49° to 57°, the process including at least the following steps:
disconnecting the supplying devices placed in the external environment from the external attachment devices of the septum to interrupt the fluid communication between the operative machines inside the controlled environment and the supplying devices,
engaging a closing element on each through opening arranged towards the external environment for defining a hermetic closure suitable for inhibiting or preventing the fluid communication between the controlled environment and the external environment,
disconnecting the operative machines, placed in the controlled-atmosphere environment, from the inner attachment devices of the main body, and in such a condition the engagement of the closing elements on the openings arranged towards the external environment inhibits or prevents the contamination of the controlled-atmosphere environment during the disconnecting of the inner attachment devices,
removing and/or substituting connecting elements and/or closing elements arranged towards the controlled-atmosphere environment,
   the hermetic closure of the openings of the septum arranged towards the external environment enabling intervention on the septum itself, avoiding the fluid communication between the external environment and controlled-atmosphere environment, keeping therefore unchanged the controlled-atmosphere conditions inside the latter.

In a sixty-third aspect, there is a partitioning wall comprising one or more septa according to any one of aspects from 1° to 48°, the partitioning wall including at least one through window engaging at least a main body of septum and at least one auxiliary body in opposition to the main body,

and wherein the septum has at least one frame stably engaged with window, the frame constraining, from one side, the main body and, from an opposite side, the auxiliary body, the frame, along with the main body and auxiliary body, defining at least one gap configured to house at least one plurality of inner attachment devices of the connecting elements.

### BRIEF DESCRIPTION OF THE DRAWINGS

Several embodiments and several aspects of the finding will be described herein below with reference to the enclosed set of drawings, provided only as a non-limiting example in which:

FIGS. 1 and 2 are perspective views of a clean room;

FIG. 3 is a top view of a clean room;

FIG. 4 is a schematization of a partitioning wall seen from the external environment;

FIG. 5 is a section view of a septum;

FIG. 6 is a detail of a septum;

FIGS. 7 to 11 schematically illustrate steps for providing a clean room;

FIG. 12 is an exploded view of a septum;

FIG. 13 is a front view of a panel;

FIGS. 14 and 15 are detail views of the panel of FIG. 13;

FIGS. 16-18 are schematizations of an intermediate body.

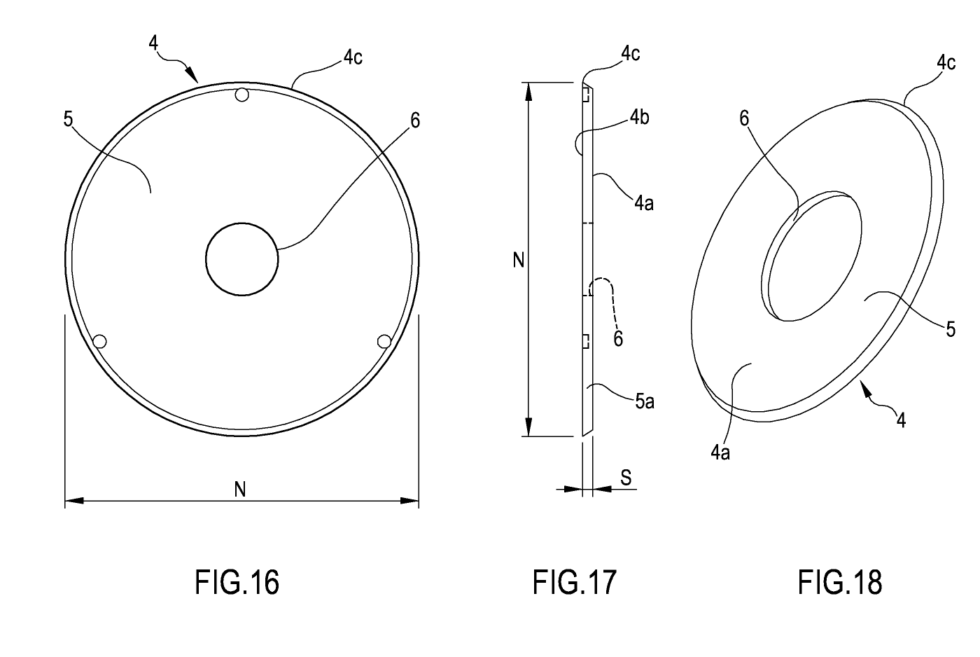

### DETAILED DESCRIPTION

### Septum (1)

In the drawings, reference number 1 overall indicates a septum for clean rooms 100. As used herein, “clean room,” generally includes any room defining at least one controlled-atmosphere environment separated from the external environment for use in the production of drugs, active principles for drugs, or for microorganism culture. Clean rooms also include clean laboratories or safety rooms; as will be better described herein below, the clean rooms 100 include a plurality of partitioning walls 102 substantially defining a room 101 with controlled-atmosphere environment C: at least one partitioning wall 102 is configured to separate a controlled-atmosphere environment C, within the room 101, from an external environment E (non-controlled atmosphere). The septum 1 can be employed for defining clean rooms 100 usable in the chemical-pharmaceutical sector for the preparation of drugs and/or in the biotechnology sector for microorganism culture. The septum 1 can also be advantageously applied for defining clean rooms 100 in making scientific research laboratories or safety rooms in which dangerous agents or substances are treated which preferably must not escape to the external environment. The specific structure of the clean rooms 100 is better analyzed further below, while in the following discussion section the structure of a septum 1 is described according to the finding.

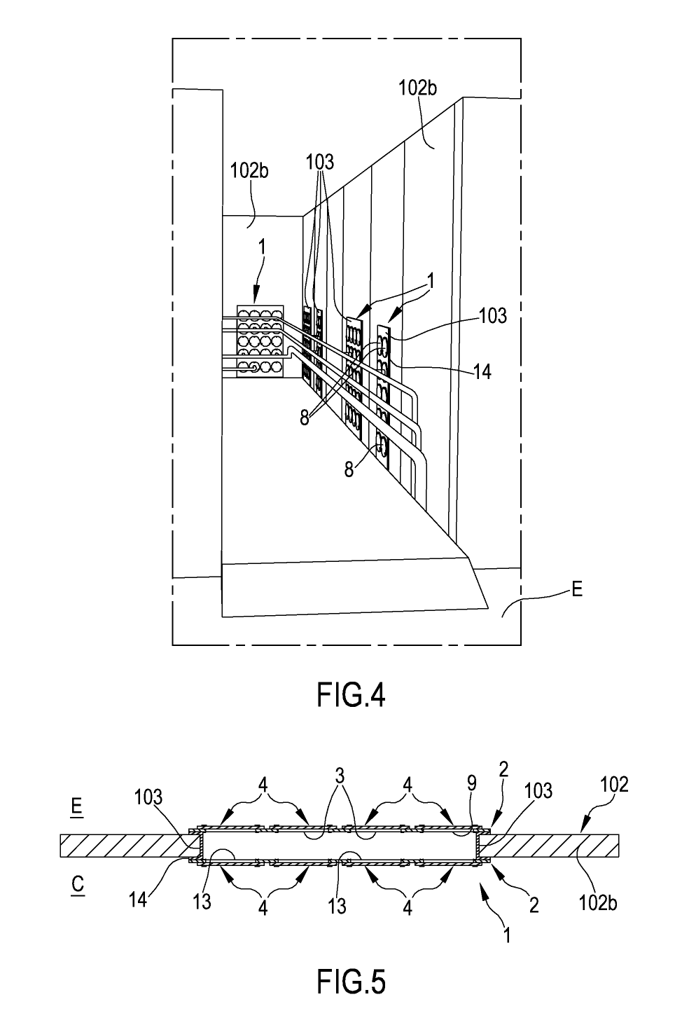

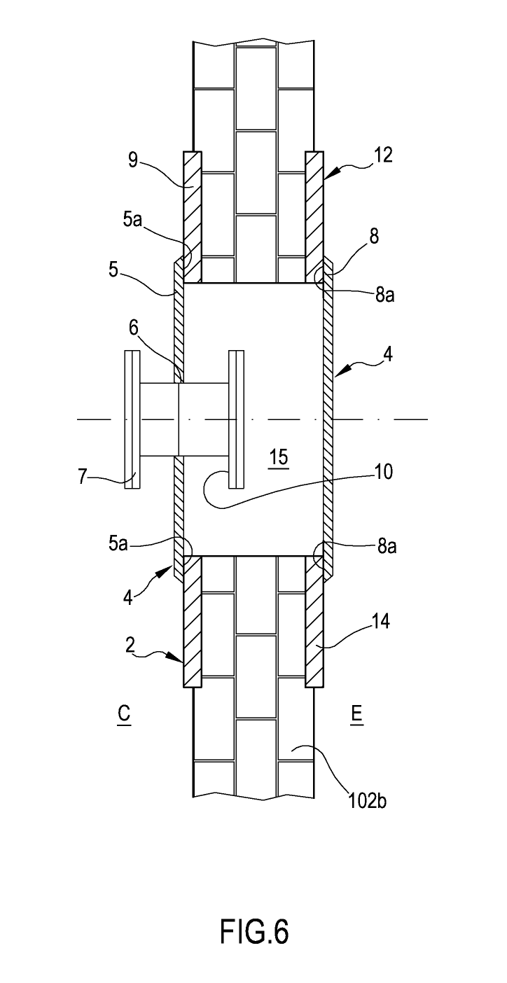

As depicted in the drawings, the septum 1 includes at least one main body 2 configured to define at least part of the partitioning wall 102. In one embodiment, the main body 2 includes at least one panel 9 separate from the partitioning wall 102 (configuration illustrated for example in FIGS. 5 and 6); in an alternative embodiment, not illustrated in the enclosed figures, the main body 2 can be defined by a portion of the partitioning wall 102 itself (in a single block with the wall itself). In the first described configuration in which the body 2 includes at least one panel 9, the septum 1 includes at least one frame 105 intended to be stably engaged inside a through window 103 executed on the partitioning wall 102: the panel 9 is stably constrained on the frame 105 which substantially defines the connection element between the panel 9 and the partitioning wall 102. The panel 9 can, for example, include a flat plate counter-shaped with respect to the frame 105 and particularly to the window 103; preferably, the panel 9 is constituted by a flat sheet having rectangular shape. It is also possible to obtain panels 9 having a shape that is, for example, circular or elliptical. With regard to the materials, the panel 9 is at least partly made of metal material; in particular the panel 9 can include or be made of steel or aluminum, with the surface finishing level required for the clean room classification.

In the second described configuration, in which the body 2 is defined directly on the partitioning wall 102, at least one portion of the wall is configured such that such portion itself defines the element of division and connection between the controlled-atmosphere environment C and the external environment E.

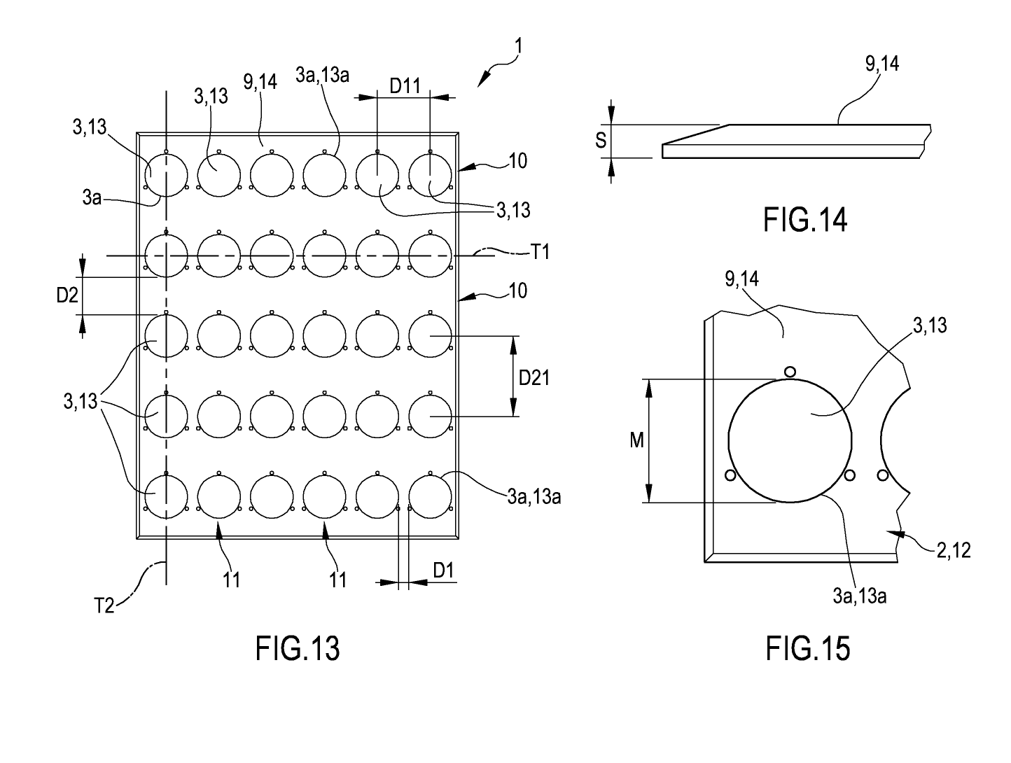

By way of example, if the body 2 is defined by at least one panel 9, the body 2 is delimited by an external perimetral edge defining an extended surface of the body 2 having area, for example, between 5,000 and 26,000 cm², or between 10,000 and 20,000 cm². The partitioning wall 102 may bear a plurality of main bodies 2 and hence panels 9. Still by way of example, the thickness S (FIG. 14) of the panel 9 may be between 3 and 7 mm, or between 4 and 6 mm. If the body 2 is formed directly on the partitioning wall 102, the thickness of the main body 2 in such case will be defined by the thickness of the partitioning wall itself, which is typically between 70 and 300 mm, or between 100 and 200 mm.

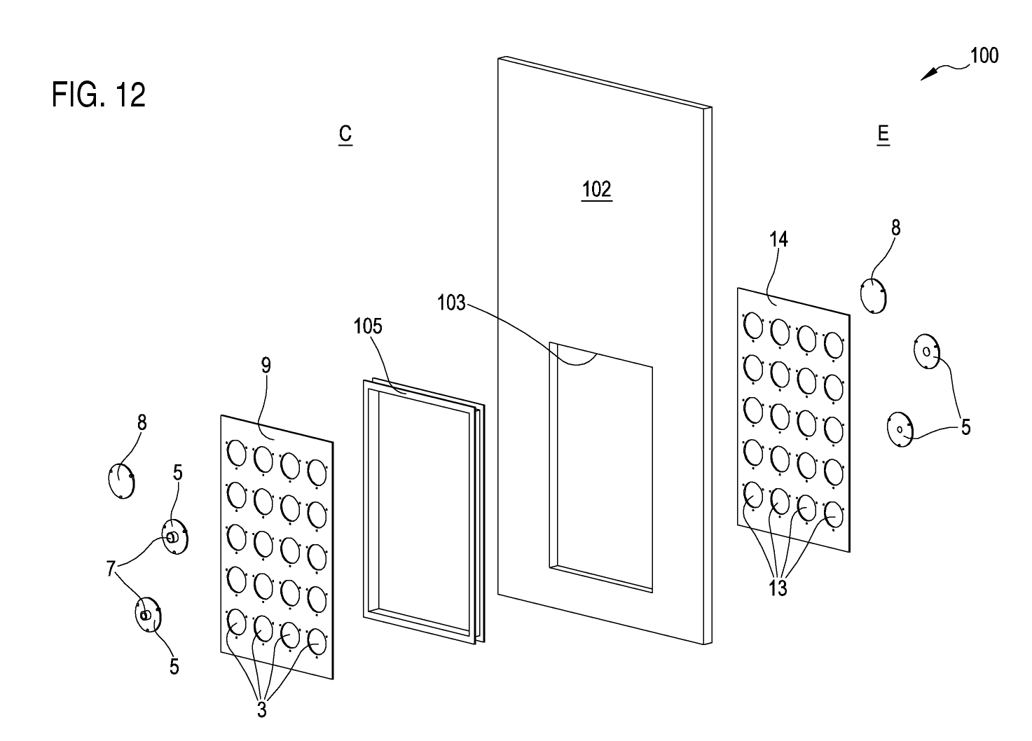

As depicted, for example, in FIG. 13, the main body 2 includes a plurality of through openings 3; in the panel configuration 9, the through openings 3 cross the plate, defining the panel 9, while in the configuration in which the main body 2 is directly defined by a portion of the partitioning wall 102, the openings 3 are defined directly on the latter and cross the entire partitioning wall 102 (A plurality (e.g., part or all) of the openings 3 may be substantially identical to each other in shape and size. In one embodiment, all the through openings 3 are identical. As depicted in the drawings, the openings 3 may be arranged in a uniform manner on multiple rows to define a matrix or “array” of openings uniformly distributed on the main body 2. As is for the example depicted in FIG. 13, the through openings 3 are, for example, uniformly distributed according to horizontal lines (trajectory T1), for example equidistant from each other. The openings may also be vertically aligned according to vertical lines (trajectory T2). The minimum distance D1, D2 between immediately adjacent through openings 3 is, for example, greater than 10 mm, or between 20 and 400 mm. In more detail, two immediately consecutive through openings 3 along the first trajectory T1 may be arranged at a minimum distance D1 from each other of between 20 and 60 mm, or between 30 and 50 mm; the minimum distance D1 is defined by the minimum distance between the perimetral edges defining the openings and is measured parallel to T1 (horizontally). The number of through openings 3 per linear meter, along the first trajectory T1, is between 3 and 10, or between 4 and 7. Likewise, two immediately-consecutive through openings 3 along the second trajectory T2 are arranged at a minimum distance D2 from each other (e.g., between 50 and 200 mm, or between 80 and 160 mm); the minimum distance D2 is defined by the minimum distance between the perimetral edges defining the openings and is measured parallel to T2 (vertically). The number of openings along T2 is between 3 and 8, or between 3 and 6. The septum 1 can overall bear a number of through openings 3 between 15 and 50 openings, or between 25 and 35 openings.

As previously mentioned, the septum 1 includes at least one plurality of openings identical to each other in shape and size. In some cases, all the openings 3 of the septum 1 are identical to each other in shape and size; nevertheless, it can happen that the septum 1 has different groups of openings 3 (different from each other), each of which constituted by a plurality of through openings 3 that are identical in shape and size with each other, but different with respect to those of another group. With regard to shape, the openings 3, for example, define a circular shape. In such a condition, it is possible to easily define the distance between consecutive openings by considering the interaxis between two openings. In fact, the interaxis D11 (FIG. 13) between two consecutive circular openings 3 arranged along the first trajectory T1 is between 100 and 300 mm, or about 200 mm. The interaxis D12 (FIG. 13) between two consecutive circular openings 3 arranged along the second trajectory T2 is between 200 and 400 mm, or about 300 mm. Nevertheless, it may be possible to make the openings 3 with elliptical or polygonal shape (e.g. rectangular). Still referring to FIG. 13, for example, it is possible to observe that each through opening 3 has an external perimetral edge defining a through area which is between 120 and 315 cm², or between 150 and 250 cm². In other words, each opening 3 has a minimum bulk M, defined by the minimum distance between two opposite edges of the opening 3 (e.g., between 120 and 200 mm, or between 150 and 180 mm) (FIG. 15). If the openings 3 have a circular shape, the bulk M of each of these is represented by the diameter, while in the case of rectangular openings, the minimum bulk is defined by the minimum width and/or length.

As depicted in FIGS. 5 and 6, the septum 1, if the main body 2 has a panel structure 9, can also include at least one auxiliary body 12 configured to define at least part of the partitioning wall 102; the auxiliary body 12 is arranged opposite to the main body 2 with respect to the partitioning wall 102 itself. In fact, in the above-described configuration, the auxiliary body 12 is adapted to be engaged with the frame 105 in order to be arranged on the opposite side with respect to the main body 2 (i.e., towards the external environment E). As depicted, for example, in the section view of FIG. 6, main body and auxiliary body 2, 12 are spaced from each other: the frame 105, together with the bodies 2 and 12, define a gap 15 whose thickness substantially coincides with the thickness of the partitioning wall 102. In more detail, the auxiliary body 12 also includes a panel 14, engaged with the frame 105, and—may have a structure similar to panel 9 of the main body 2. In one embodiment, the panel 14 of the auxiliary body 12 is identical to the panel 9. Indeed, as with the main body 2, the auxiliary body 12 may include a plurality of through openings 13 identical to each other and in opposition to the plurality of through openings 3 of the main body 2; with each through opening 13 of the auxiliary body 12 in fluid communication with at least one through opening 3 of the main body 2. In more detail, the panel 14 may be identical to the panel 9 also in relation to the number, size and position of the through openings. As with the panel 9, also the panel 14 of the auxiliary body 12 may be at least partly made of metal material; in particular, the panel 14 may include or be made of steel or aluminum.

Continuing with the analysis of the structure of the septum 1, it is possible to observe that the latter also includes a plurality of intermediate bodies 4, each of which is adapted to be stably engaged with the through openings 3 of the main body 2 towards the side of the controlled-atmosphere environment C and/or towards the external environment E. In the configuration in which the main body 2 is constituted by at least part of the partitioning wall 102, the intermediate bodies 4 may be configured for being directly engaged on the latter on one side arranged towards the controlled environment C (volume inside the room 101) and/or towards the external environment E (outside the room 101).

On the other hand, in the configuration in which the main body 2 is at least partly constituted by a panel 9, the intermediate bodies 4 are configured for being directly engaged with the latter, at the through openings 3, arranged towards the controlled environment C; as previously mentioned. In such a condition, the septum 1 may also include an auxiliary body 12: the intermediate bodies 4 are configured for being directly engaged with the panel 14, at the through openings 13, arranged towards the external environment E.

Each intermediate body 4 may include a plate extended between a first and second main extension surface 4a, 4b (FIG. 17): in a condition of engagement of the intermediate body 4 to the main body 2 and/or auxiliary body 12, the first and second extension surface 4a, 4b are respectively configured to be arranged towards the controlled-atmosphere environment C and towards the external environment E. With regard to geometry, each intermediate body 4 has an external perimetral edge 4c counter-shaped with respect to the through openings 3 or 13. In the drawings, configurations are illustrated in which the intermediate bodies 4 have a circular (disc) shape. Nevertheless it is possible to obtain intermediate bodies 4 defining a shape that is different from the shape of the openings (e.g., a rectangular or elliptical shape).

With regard to size, it is useful to observe that each intermediate body 4 has increased shape with respect to the shape of the opening 3, 13 in a manner such that, in engagement condition, the intermediate body 4 can entirely cover the opening 3 or 13; each intermediate body 4 is configured for preventing lateral fluid leakage (fluid passages) from the perimetral edge thereof: the fluid seal between body 2 and/or 12 and intermediate body 4, at the perimetral edge thereof, is hermetic (the seal can be ensured by the suitable surface processing of the materials and/or by the presence of gaskets interposed between intermediate body 4 and body 2 and/or 12). In more detail, the external perimetral edge 4c of the intermediate body 4 delimits a front area greater than the through area of each opening 3: the external perimetral edge 4c overlappingly acting on a perimetral edge 3a defining the opening 3 with which the intermediate body 4 is associated. The front area is between 150 and 350 cm², or between 200 and 300 cm². In still greater detail, each intermediate body 4 has a minimum bulk N, defined by the minimum distance between two opposite edges of the intermediate body 4 itself. In the configuration in which the intermediate body 4 defines a circular shape as illustrated in the drawings, the minimum bulk N is represented by the diameter thereof (FIG. 17). In an alternative configuration, for example, represented by intermediate bodies 4 having a rectangular shape, the minimum bulk N is defined by the minimum distance between opposite edges representing the width or the length of the intermediate body 4. Quantitatively, the minimum bulk N is between 140 and 220 mm, or between 170 and 195 mm. It is also possible to define the size of the intermediate bodies 4 by comparing the surface area extension of the latter with the through area of the openings 3, 13 with which they are associated. Indeed, the ratio between the front area of the intermediate body 4 and the through area of the opening 3 (likewise of the passage opening 13) is greater than 1, or between 1.01 and 1.5. Each intermediate body 4 also has a thickness, defined by the distance between the first and the second main extension surface 4a, 4b, of between 2.5 and 10 mm, or between 3 and 6 mm. With regard to materials, each intermediate body 4 can be at least partly made of metal material, in particular each of the intermediate bodies 4 can include or be made of steel or aluminum, with the surface finishing level required for the clean room classification.

In some cases, the septum 1 has at least one plurality of openings 3 (consequently a plurality of through openings 13) that are equivalent to each other. Likewise, there may be at least one plurality of intermediate bodies 4 that are equivalent to each other. In certain cases, all the intermediate bodies 4 are substantially equivalent to each other in shape and size.

As depicted in the drawings, the plurality of intermediate bodies 4 may include at least two types of elements engageable with through openings 3: connecting elements 5, and closing elements 8.

Herein below, the structure and function of the connecting elements 5 are first described; then, the structure and function of the closing elements 8 are described. Each connecting element 5 is engageable to the main body 2: in particular, each connecting element 5 is configured to engage the partitioning wall 102 when the main body 2 is at least partly constituted by the wall, or it is engageable to the panel 9 and/or to the panel 14.

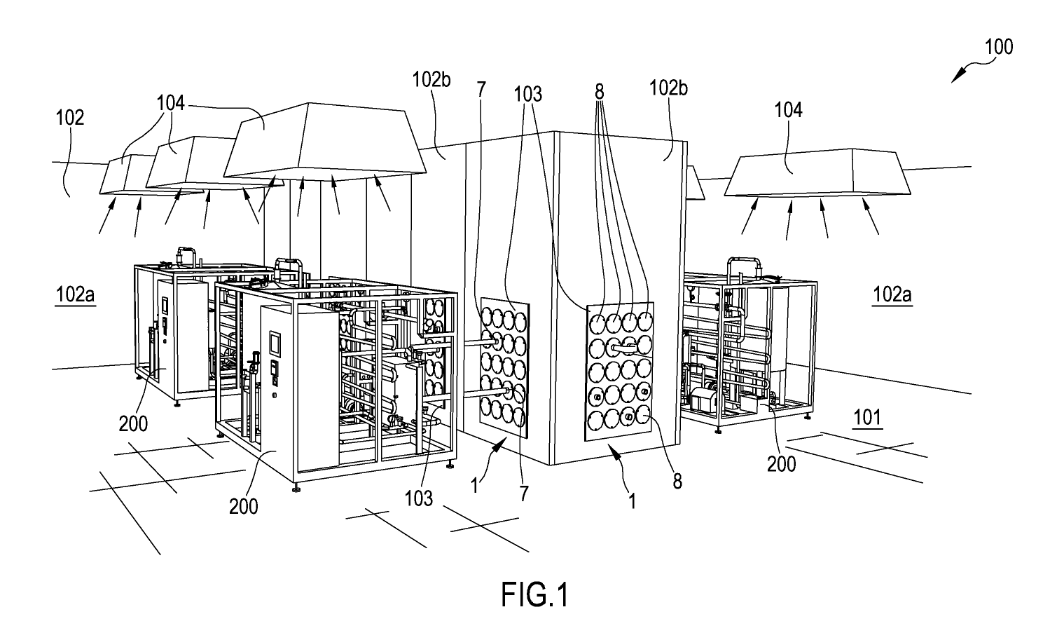

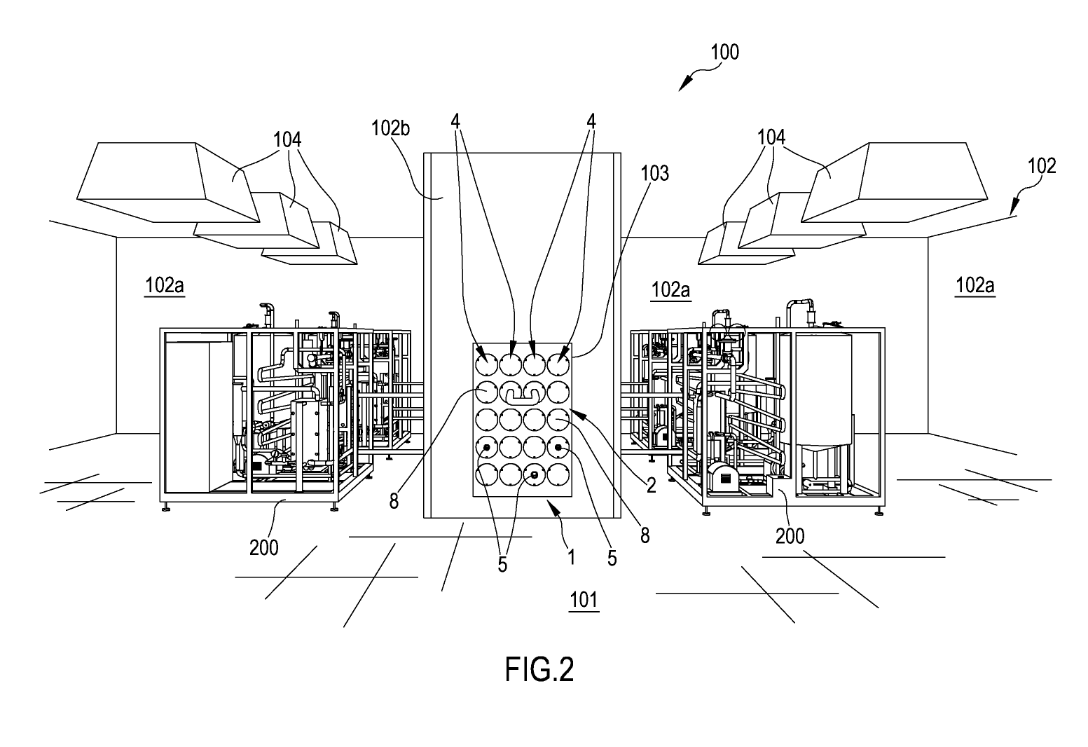

Each connecting element 5 has at least one through hole 6 and at least one inner attachment device 7 engaged at the through hole 6: the inner attachment device 7 is suitable for being connected to operative devices or machines 200 housed inside the room 101 (FIGS. 1 and 3). Each connecting element 5 has a coupling surface 5a suitable for being interchangeably combined with each opening 3 of the body 2, particularly with each of the openings 3 and 13, respectively, of the panels 9 and 14. The coupling surface 5a of each connecting element 5 defines a hermetic perimetral closure with the respective opening (through opening 3 and/or 13) suitable for preventing fluid leakage through the side edge of the element 5 itself; nevertheless, the connecting element 5 has a through hole 6 arranged, in a non-limiting manner, at the center of the element 5 itself and adapted to allow the crossing of substances by means of the inner attachment device 7. As described above, all the openings are may be identical to each other; likewise, at least the coupling surfaces 5a of the connecting elements 5 are identical to each other in order to be interchangeably combined with each opening 3, particularly with the openings 3 and 13. The inner attachment device 7 includes at least one connector and/or a quick connection in fluid communication with the through hole 6 and configured to be directly or indirectly connected to operative devices or machines 200 housed inside the controlled-atmosphere environment C (FIG. 1). The inner attachment device 7 is configured for receiving one or more tubes adapted to place devices 200 in fluid communication with the passage hole 6. The inner attachment device may include valve members (e.g., a respective check valve) or closure taps that can be manually or automatically activated.

As depicted in FIGS. 3 and 6, each connecting element 5 also has at least one external attachment device 10 engaged at the through hole 6 and in opposition to an inner attachment device 7. The attachment device 10 includes at least one connector and/or a quick connection in fluid communication with the through hole 6 and configured for being directly or indirectly connected with supplying devices 300 housed in the external environment E (FIG. 3). The external attachment device 10 may be configured for receiving one or more tubes adapted to place the supplying devices 300 in fluid communication with the passage opening 6.

The inner and external attachment devices 7, 10 are in fluid communication via the through hole 6 and are respectively configured for enabling the fluid communication (e.g., via tubes) between the operative machines 200, inside the controlled-atmosphere environment C, and the supplying devices 300 housed in the external environment E. In some cases, all the connecting elements 5 have coupling surfaces 5a identical to each other in shape and size in a manner such that the elements 5 can engage all the openings 3 (consequently all the openings 13); nevertheless, the connecting elements 5 can have attachment devices 7, 10 and through hole 6 that differ from one element 5 to another so as to meet all the coupling and flow rate needs possible. In certain cases, based on the required flow rate and/or based on the type of attachment (7, 10) for connecting with the operative machines 200 and the supplying devices 300, it is possible that there will be connecting elements 5 having holes 6 and/or attachment devices 7/10 that are different from each other. In some implementations, the through hole 6 is a hole or a channel adapted to allow the passage and the engagement between the attachments 7, 10. In some implementations, the hole 6 is at least one hole or one threaded channel: in such a condition, and the hole directly engages at least one of the attachments 7, 10 which are then engaged with each other. With regard to size, the through hole 6 defines a passage section having area between 90 and 5,000 mm², or between 120 and 4,300 mm².

As mentioned previously and as is depicted in the drawings, the plurality of intermediate bodies 4 may include a plurality of closing elements 8, each of which is engageable at least with the plurality of through openings 3, or with the openings 3 and 13, and configured for defining a hermetic closure suitable for inhibiting or preventing the fluid communication between controlled environment C and external environment E. In certain cases, the closing elements 8 have the same shape and size and are interchangeably and closeably engageable with each of the through openings 3 and 13.

Each closing element 8 is engageable with the main body 2 (it is configured to engage the partitioning wall 102 when the main body 2 is at least partly constituted by the wall 102), in particular it may be engageable with the panel 9 and/or with the panel 14. With regard to shape, each closing element 8 includes a blind body, devoid of through openings: each closing element 8 is configured to hermetically close the through opening 3 and/or 13 with which it is associated and prevent fluid leakage through the side edge of the element 8 itself. In particular, each closing element 8 has a coupling surface 8a suitable for being interchangeably combined with each of the through openings 3 and 13. As described above, in some cases, all the openings 3, in particular 3 and 13, are identical to each other; likewise, at least the coupling surfaces 8a of each closing element 8 are identical to each other in order to be interchangeably combined with each opening 3, particularly with the openings 3 and 13. In certain cases, the coupling surfaces 5a, 8a, respectively, of the connecting elements 5 and of the closing elements 8, are identical to each other, such that the latter can be interchangeably engaged with all the openings.

### Clean Room (100)

Clean room 100, particularly for producing drugs or active principles or for microorganism culture, includes a plurality of partitioning walls 102 which define a room defining a controlled-atmosphere environment C.

The room includes at least one filtration device 104 associated with at least one of the partitioning walls 102 and configured to supply filtered or super-filtered air for defining the controlled-atmosphere environment C.

At least one of the walls 102 is configured to separate a controlled-atmosphere environment C, inside the room 101, from an external not controlled-atmosphere environment E. The wall 102 can for example be a peripheral wall (external perimeter) or it can include one or more walls emerging from one or more perimetral walls towards the interior of the room 101.

At least one of the walls 102 includes one or more septa 1 configured to separate the controlled-atmosphere environment inside the room 101 from the outside and simultaneously enable the passage inside the same room of substances (e.g., work fluids), for a process underway inside the room itself. The clean room 100 is configured to house a plurality of operative devices or machines 200 therein (e.g., machines for treating substances adapted to form drugs or active principles or for the cultivation of microorganisms). The clean room 100 can provide for only one septum 1 adapted to allow the connection with all the devices inside the room or it can provide for a plurality of septa 1, each of which is adapted to serve one or more respective devices 200 present inside the room.

In some embodiments, the clean room 100 includes a plurality of septa 1: each septum 1 is configured to be connected to only one device 200 for treating substances. For example, one septum 1 can be connected to a machine for homogenizing substances, another septum 1 may only be connected to a machine for centrifuging the substances. It is useful to specify that the partitioning walls 102 may include a plurality of external perimetral partitioning walls 102a perimetrically defining the room 101 and at least one plurality of operative walls 102b emerging from the external perimetral partitioning walls 102a according to a direction entering the room 101.

The septum 1 can be associated with the perimetral wall 102a and/or with the operative wall 102b. In some cases, a plurality of septa 1 are present, all associated with the operative walls 102b inside the room 101.

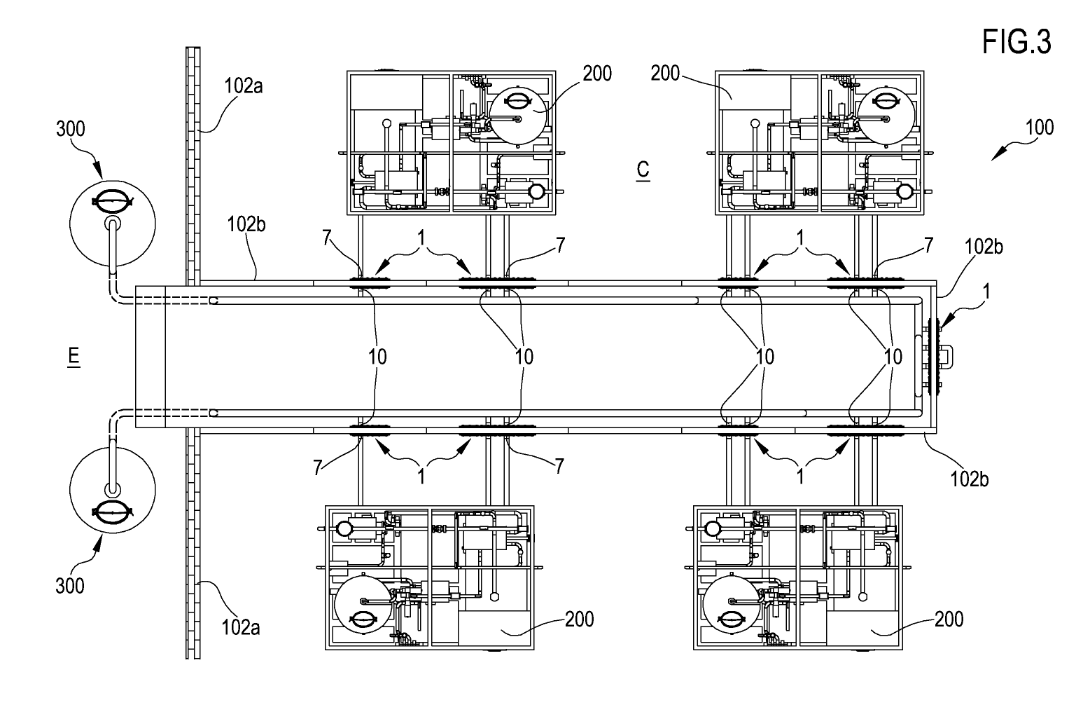

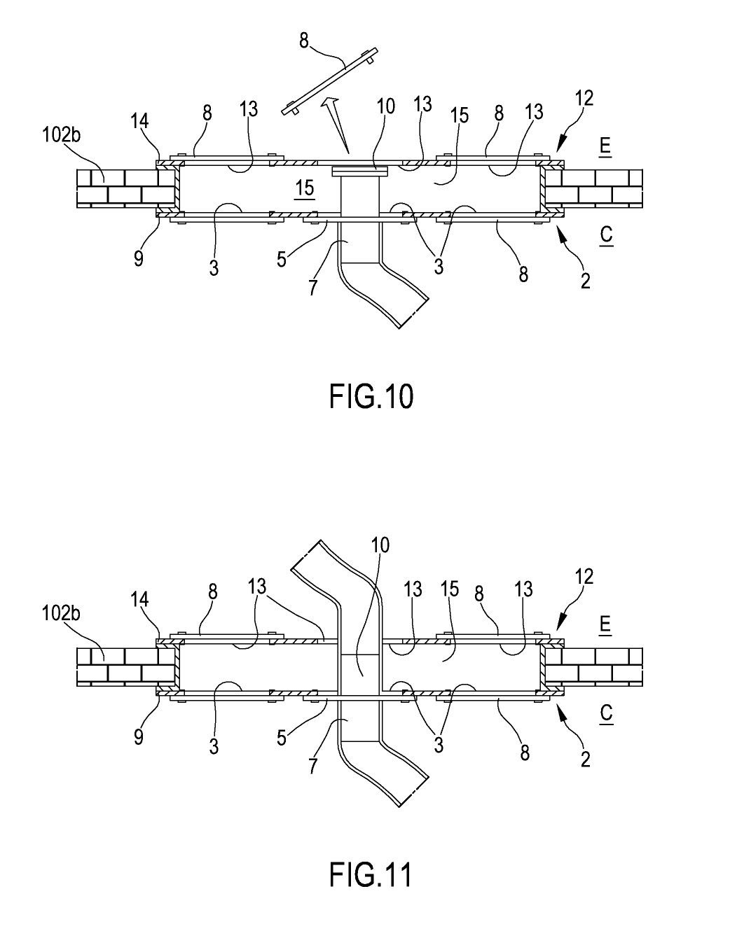

As is depicted, for example, in the exploded view of FIG. 12, the partitioning wall 102 includes at least one through window 103 configured to stably engage the frame 105 of a septum, which then constrains at least one panel 9 and/or 14. In the configuration depicted in FIGS. 1 and 4, the partitioning wall 102 includes a plurality of windows 103, each engaging a respective septum 1. In some cases, each window 103 engages a panel 9 of the main body 2 arranged towards the controlled-atmosphere environment C and a panel 14 of the auxiliary body 12, opposite the main body 2 with respect to the partitioning wall 102 itself, arranged towards the external environment E; the frame 105, together with the panels 9, 14, define a gap 15. Both the main body 2 and the auxiliary body 12 are configured to interchangeably engage the intermediate bodies 4, particularly the connecting elements 5 and the closing elements 8. As depicted in FIG. 2, the main body 2 (optionally the panel 9) bears a plurality of connecting elements 5 and a plurality of closing elements 8; the auxiliary body 12 (optionally the panel 14) bears, as a non-limiting example, a plurality of closing elements 8 (FIG. 4).

In fact, based on the type and number of operative machines 200 placed in the room 101, it is possible to establish the number and type of connecting elements 5 to be placed on the main body 2 (on the panel 9). The remaining openings 3 of the main body 2, not occupied by connecting elements 5, are hermetically closed by respective closing elements 8. In such a condition, only the connecting elements 5, bearing the attachments 7, 10, can define the connection between the supplying devices 300 (external environment E) and the operative machines 200 placed in the room (controlled-atmosphere environment C). In order for the attachments 7, 10 to receive the tubes connected to the supplying devices 300, the openings 13 of the auxiliary body 12, opposite the openings 3 engaging the connecting elements 5, must be free, i.e. they must not bear closing elements 8 which are adapted to hermetically close the passage of the opening 13, thus preventing the passage of tubes.

### Process for Providing a Clean Room (100)

Also described herein is a process for providing a clean room 100 equipped with at least one filtration device 104 configured to supply, within such room, filtered or super-filtered air for defining a controlled-atmosphere environment C. The process may provide for the arrangement of the room 101 with at least one partitioning wall 102 interposed between a controlled-atmosphere environment C and an external environment E. The process may also provide for arranging, at the partitioning wall 102, at least one septum 1 configured to define at least part of the partitioning wall 102.

As described herein, the main body 2 of the septum 1 can be an integral part of the wall 102 or it can be constituted by one or more panels 9 and/or 14 separate from the wall 102. If the septum is an integral part of the wall 102, the arrangement of the septum 1 provides for obtaining a plurality of through openings 3 directly on the wall. In some cases, the septum 1 provides for a panel structure 9, 14 separate from the partitioning wall 102. In such a condition, providing the partitioning wall 102 provides for defining, on the latter, one or more through windows 103 as described herein. The process may also provide for the stable engagement of a frame 105 within each window 103: the frame 105 is adapted to stably constrain the panels 9 and 14 respectively configured for being arranged towards the inner environment of the room 101 and towards the external environment E. In the panel configuration 9, 14, such panels may be positioned in a relation of mutual opposition and define the gap 15. In such a condition, the openings 3 are defined directly on the panel 9 while the openings 13 are defined directly on the panel 14.

The process also provides for the formation of the intermediate bodies 4, for example, the formation of a plurality of connecting elements 5 and a plurality of closing elements 8. In some cases, each intermediate body 4 is adapted to be interchangeably engaged with the through openings 3 and/or 13 respectively of the main body 2 and of the auxiliary body 12. In certain cases, the connecting elements 5 provide for at least one attachment device 7 (e.g., an inner attachment device 7 arranged towards the environment inside the room 101 and an external attachment device 10 arranged towards the environment outside the room 101).

The intermediate bodies 4 may be engaged with the through openings 3 and/or 13. In a step for defining the controlled-atmosphere environment C, the process can provide for the engagement of the closing bodies 8 on all the through openings 3, particularly on the openings 3 and/or 13, in a manner so as to hermetically close them: such step inhibits or prevents the external environment E from directly communicating with the environment inside the room 101 (FIG. 5). All the through openings 3 and 13, respectively of the main body 2 and of the auxiliary body 12, may sealed by respective closing bodies 8.

Following the closure of the openings 3 and/or 13, the process provides for the definition of the controlled-atmosphere environment C inside the room 101: for example, outside air can be made to pass through the filter 104.

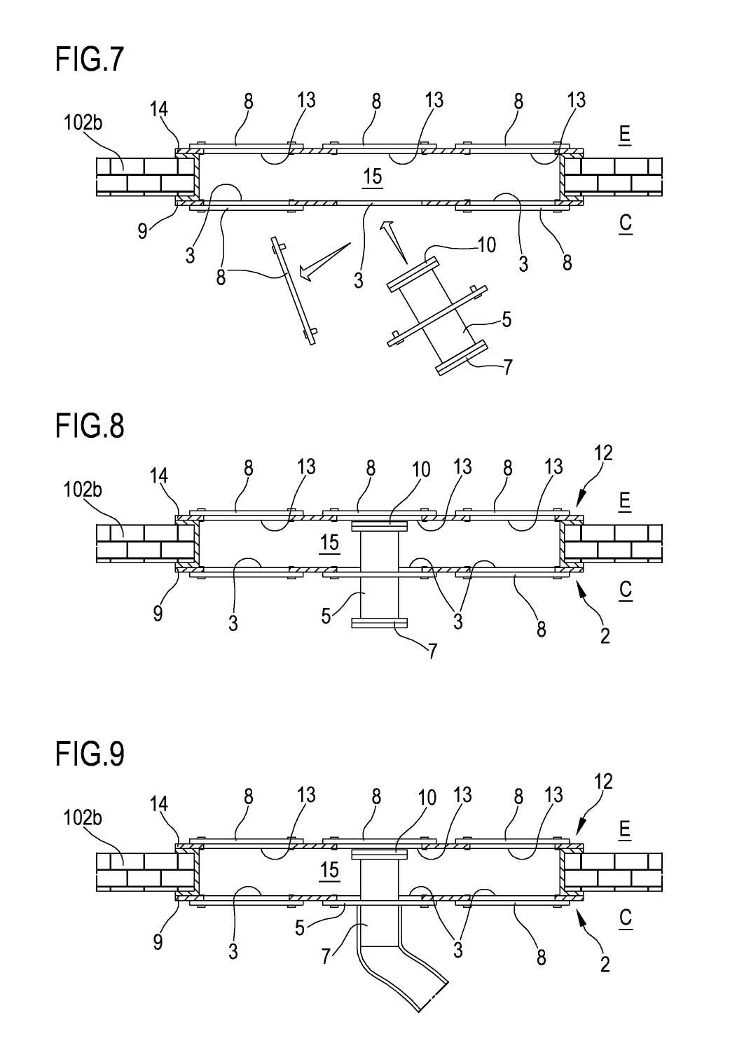

Following the definition of the controlled environment C, it is possible to proceed with the arrangement of the connection with the operative machines 200, inside the room. The closing elements 8 may be engaged with the through openings 13 arranged towards the external environment E while on the inner side (controlled-atmosphere environment C), at least some of the closing elements 8 are substituted with connecting elements 5. In more detail, on the controlled environment C side (panel 9 of the main body 2), the connecting elements 5 are arranged which are configured for being connected (e.g., by tubes) to the operative machines 200 arranged inside the room 101 (FIGS. 7 and 8). In still greater detail, the attachment device 7 of each connecting element 5 is configured for receiving in engagement a respective tube connected to an operative machine 200 placed inside the room 101 (FIG. 9). The external attachment devices 10 are arranged on the opposite side, housed inside the gap 15.

After the connection of the operative machines 200 present in the controlled-atmosphere environment C to the attachments 7, the process provides for the removal of the closing elements 8, opposite the connecting elements 5 (FIG. 10). The removal of such closing elements 8 allows the access to the gap 15 for the connection (e.g., by tubes) to the external attachment devices 10 of the connecting elements 5. The process then provides for the connection (e.g., by tubes) of one or more supplying devices 300 with the external attachments 10 (FIG. 11). After the connection (e.g., by tubes), to the external attachment devices 10, the process provides for sending substances (e.g., work fluids) through the attachments 7, 10 to the operative machines 200 housed inside the clean room 100. The substances sent by the supplying devices 300 (e.g., by tubes) reach the respective connecting elements 5 which allow the introduction thereof inside the room 101. Therefore, the substances sent inside the clean room 100 through the attachments 7, 10 do not come into direct contact with the controlled atmosphere C but are introduced inside the operative machines 200. Such process in fact prevents the external environment (dirty side) from coming into direct contact with the controlled-atmosphere environment C of the clean room 100.

If it is necessary to proceed with the disconnection, substitution or addition of connecting elements 5 arranged towards the controlled-atmosphere environment C side, the process provides for the following.

Before disengaging a connecting element 5, there is the closure of the dirty side by, for example, a corresponding closing element 8. Thus, once the removal of the connecting elements 5 has been completed, it is possible to keep the controlled-atmosphere environment C separate from the external environment E. The removed connecting element 5 can be substituted with a different connecting element 5 or with a closing element 8: in any case, the reconfiguration of the room 100 and the modification of the connection of the operative machines 200 on the controlled-atmosphere environment C side avoids problems of contamination from the room 100.

In the case of addition of a connecting element 5, this is installed in place of a closing element 8 operating on the internal side of the septum 1, leaving the corresponding opposite closing element 8 on the external side in conditions of hermetic seal engagement: in this manner, the addition of a connecting element 5 does not compromise the controlled atmosphere. Once the new connecting element 5 is connected with the respective operative machine 200, one can proceed with the removal of the external closing element 8 and with the connection of the connecting element 5 just installed with the possible substance sources (e.g., work fluids).

The configuration of the septum 1 described herein can provide several advantages. The presence of through openings 3 (optionally of through openings 13) identical to each other, allows the obtainment of intermediate bodies 4 that are all equivalent and engageable with any one opening. Thus the septum 1 is capable of defining a very flexible system that can be adapted to the various configurations of the clean room. Indeed, the same septum 1 can be used for the clean room 100 both in pilot plant configuration (starting plant for small-medium size production) and in clean room configuration aimed for large-scale production. The provision of a plurality of openings that are equivalent to each other enables engaging, in a desired manner, connecting elements 5 configured to allow the passage of substances and closing elements 8 for preventing the fluid communication between the controlled environment C and the external environment E.

In some cases, the provision of only one type of intermediate bodies 4 considerably reduces the costs of the septum 1, which will substantially only provide for one type of openings 3, 13. The septum can also be simply and quickly connected with the devices present inside the clean room 100.

The particular structure of the septum 1 can significantly reduce the time required to attain direct fluid communication between the controlled environment C and the external environment E during the steps of configuration of the clean room (e.g., in the initial mounting and reconfiguration steps). In addition, the septum 1 and the relative use process are adapted for preventing the undesired passage of contaminating substances to the interior of the controlled environment C of the room itself.

In certain cases, the structure of the septum 1 is thus that of being able to achieve a facilitated clean room 100 configuration process that is particularly simple, safe and which prevents, after the definition of the controlled environment C, the contamination thereof. The process is capable of keeping the controlled environment C conditions inside the clean room 100 even during the steps of modification and/or arrangement of the septum 1. The ability to keep one side of the septum 1 substantially sealed during the arrangement and connection of the other side prevents the direct fluid communication between the controlled environment and the external environment, hence preventing the contamination of the room 101. In addition to not having to completely redesign and reconstruct the separation septum 1 each time the room 100 is reconfigured, the fact that it is not required to re-establish the controlled-atmosphere conditions C after each reconfiguration of the septum 1 allows considerable reduction in the implementation times and costs of each modification. In some cases, once the controlled-atmosphere conditions C have been established, the latter may not be altered by possible reconfigurations of the clean room 100.

What is claimed is:

1. A clean room septum comprising:
a main body configured to at least partially define a portion of a partitioning wall configured to separate an inner controlled-atmosphere environment from an external environment, the main body defining a plurality of through openings substantially identical to each other in shape and size; and
a plurality of intermediate bodies, each intermediate body configured to stably engage a through opening and each extending between a first and a second main development surface respectively configured to be arranged towards the controlled-atmosphere environment and towards the external environment, the plurality of intermediate bodies comprising:
a plurality of connecting elements engageable with the through openings, each connecting element having at least one through hole and an inner attachment device at the through hole, the inner attachment device adapted for connecting with operative devices or machines housed inside a room, and
a plurality of closing elements, each closing element comprising a blind body devoid of through openings, and each being hermetically engageable with the through openings and being configured to hermetically close the through opening with which it is associated.

2. The clean room septum according to claim 1, wherein each connecting element has a coupling surface suitable for being interchangeably coupled to each of the through openings, and wherein each closing element has a coupling surface suitable for being interchangeably coupled to each of the through openings.

3. The clean room septum according to claim 2, wherein the coupling surfaces of the connecting elements and the coupling surfaces of the closing elements are identical to each other in shape and size.

4. The clean room septum according to claim 1, comprising at least one frame suitable for being engaged with at least one through window of the partitioning wall, the main body comprising at least one panel configured to stably engage the frame.

5. The clean room septum according to claim 1, wherein each of the connecting elements has at least one external attachment device engaged at the through hole opposite to and in fluid communication with the respective inner attachment device by the through hole.

6. The clean room septum according to claim 1, wherein each intermediate body has an external perimetral edge defining a front area greater than the through area of each opening, the external perimetral edge overlappingly acting on a perimetral edge defining the opening with which the intermediate body is associated.

7. The clean room septum according to claim 1, comprising at least one auxiliary body configured to define at least a portion of the partitioning wall, the auxiliary body being placed in opposition to the main body with respect to the partitioning wall and comprising a plurality of through openings identical to each other and in opposition to the plurality of through openings of the main body.

8. The clean room septum according to claim 7, wherein at least the plurality of through openings of auxiliary body are substantially identical in shape and size to the plurality of through openings of main body.

9. The clean room septum according to claim 7, wherein the closing elements of the intermediate bodies are interchangeably engageable with each of the through openings of the auxiliary body.

10. The clean room septum according to claim 1, wherein the openings of the plurality of openings are uniformly distributed on the main body to define a matrix of openings.

11. The clean room septum according to claim 10, wherein the openings are uniformly distributed along a first trajectory, the septum defining a number of openings per linear meter along the first trajectory between 3 and 10 inclusive, and wherein the openings are uniformly distributed along a second trajectory, the septum defining a number of openings per linear meter along the second trajectory between 3 and 8 inclusive.

12. The clean room septum according to claim 10, wherein the main body comprises a number of openings between 15 and 50 inclusive.

13. A clean room septum comprising:
a main body comprising a panel and configured to at least partially define a portion of a partitioning wall configured to separate an inner controlled-atmosphere environment from an external environment, the main body comprising a plurality of through openings substantially identical to each other in shape and size;
an auxiliary body comprising a panel and configured to define at least part of the partitioning wall, the auxiliary body being placed opposite the main body with respect to the partitioning wall, the auxiliary body comprising a plurality of through openings identical to each other and in opposition to the plurality of through openings of the main body;
a frame suitable for being engaged with at least one through window of the partitioning wall, the panel of the main body and the panel of the auxiliary body being configured to stably engage the frame; and
a plurality of intermediate bodies, each intermediate body configured to stably engage the through openings of the main body, each intermediate body extending between a first and a second main development surface respectively configured to be arranged towards the controlled-atmosphere environment) and towards the external environment, the plurality of intermediate bodies comprising:
a plurality of connecting elements engageable with the through openings of the main body, each connecting element having at least one through hole and an inner attachment device at the through hole, the inner attachment device being suitable for being connected to operative devices or machines housed inside a room, and
a plurality of closing elements, each of which is hermetically engageable with the through openings of the main body,
wherein at least the plurality of through openings of the auxiliary body is substantially identical in shape and size to the plurality of through openings of the main body.

14. The clean room septum according to claim 13, wherein the panel of the auxiliary body is substantially identical to the panel of the main body.

15. The clean room septum according to claim 13, wherein the closing elements of the intermediate bodies are interchangeably engageable with each of the through openings of the auxiliary body.

16. The clean room septum according to claim 13, wherein each connecting element has a coupling surface suitable for being interchangeably combined with each of the openings of the main body, and wherein each closing element has a coupling surface suitable for being interchangeably combined with each of the through openings of the main body.

17. The clean room septum according to claim 13, wherein the coupling surfaces respectively of the connecting elements and the closing elements are identical to each other in shape and size.

18. The clean room septum according to claim 13, wherein the closing elements have the same shape and size, the closing elements being interchangeably and closeably engageable with each of the through openings of the main body.

19. The clean room septum according to claim 13, wherein each of the connecting elements has at least one external attachment device engaged at the through hole, opposite to and in fluid communication with the respective inner attachment device via the through hole.
